(19) United States
(12) Patent Application Publication
(10) Pub. No.: US 2024/0013674 A1
(43) Pub. Date: Jan. 11, 2024

(54) Educational Instrument and Method

(71) Applicant: Aissatou Kesso Diallo, Washington, DC (US)

(72) Inventor: Aissatou Kesso Diallo, Washington, DC (US)

(21) Appl. No.: 17/857,349

(22) Filed: Jul. 5, 2022

(51) Int. Cl. G09B 19/00

(52) U.S. Cl. CPC G09B 19/003

(57) ABSTRACT

A teaching implement for teaching cyclical concepts comprising a plurality of pages, each page capable of serving as a front cover, a back cover, or an interior page of the teaching implement; a plurality of binding segments wherein at least one binding segment is attached to each page, each binding segment also being attached to at least one other binding segment and wherein any set of adjacent attached binding segments may serve as a spine for the teaching implement, and an associated method of presenting information or writing a story designed for the aforementioned teaching implement.

### FIELD OF THE INVENTION

The present invention generally relates to a design of a teaching implement (or book) and an associated method of creating a looping story composition that is facilitated by the design of the teaching implement.

### BACKGROUND OF THE INVENTION

Reading is an essential part of learning. It shapes the way children develop their method of thinking and how they relate concepts to the real world. Traditionally, books contain a beginning, middle, and end. These books and their stories or contained information may be viewed as compact units of the flow of time and this linear relationship may limit a child's learning and creativity. Further, such limitations may affect the development of the child's problem-solving skills because the child may focus on a singular, possibly linear, solution to the problem opposed to a nuanced approach that considers factors beyond the immediate issue and situation.

Students typically learn about various cycles during their education. The cycle of the seasons through the year, the cycle of birth, development, reproduction, and death, the greater cycle of life affecting multiple organisms in a biome, the recycling process for plastics and other materials, etc. are some examples of the cyclical concepts which children must learn. However, learning of cyclical concepts are not limited to grade school-aged children. Cyclical concepts such as the yearly fiscal cycle for companies, the expansion and retraction of an economy, feedback and optimization routines or loops, and socioeconomic impacts and outcomes are some examples of higher-level cyclical concepts that adolescents or adults also benefit from understanding. Despite cyclical events and processes being very common in our lives, there are very few teaching implements to aid children in understanding these concept. Therefore, there exists a need for a teaching implement, such as a looping book, that helps individuals understand that cycles can be approached at any entry point, may loop infinitely, and can affect them throughout their lives.

### SUMMARY OF THE INVENTION

The following presents a simplified summary of the present invention to provide a basic understanding of the invention's concepts. This summary is not an extensive overview, and it is not intended to identify critical elements or to limit the scope of this disclosure. The sole purpose of this summary is to present some general concepts in a simplified form as a prelude to the detailed description of the invention.

The subject matter disclosed and claimed herein, in some embodiments of the present invention, relates to a teaching implement for teaching cyclical concepts, comprising a plurality of pages, each page having two sides, each page having an inner portion and an outer portion, and each page capable of serving as a front cover, a back cover, or an interior page of the teaching implement; and a plurality of binding segments wherein at least one binding segment is attached to each page at the inner portion of that page, each binding segment being attached to at least one other binding segment, and wherein any set of adjacent attached binding segments may serve as a spine for the teaching implement.

In some embodiments, each binding segment is part of a cluster of binding segments coupled at their respective ends opposite those binding segments' attachments to their respective pages, and wherein at least one pair of binding segments are coupled at a point between their ends in the cluster and ends attached to the their respective pages, creating a pocket having an interior and exterior, and wherein the interior of the pocket contains the clusters of coupled binding segments and the exterior of the pocket serves as the teaching implement's spine.

In alternative embodiments, each page has two attached binding segments, the first binding segment attached to one side of the page at the inner portion and the second binding segment attached to the other side of the same page at the inner portion, and wherein the two binding segments attached to one page are attached to binding segments of different pages creating a pocket with an interior containing the ends of the binding segments opposite of the end of each binding segment attached to its respective page and an exterior serving as the teaching implement's spine.

The subject matter disclosed and claimed herein, in some embodiments relates to a method of writing designed for a teaching implement for teaching cyclical concepts, the method comprising writing the content of each page of the teaching implement so that each page contains a portion of a story arc that is part of a greater story conveyed through the thematically connected story arcs of the plurality of pages that comprise the teaching implement; structuring each page such that the words leave room for an attractive image and identifying information of the teaching implement to be displayed on each page; having the attractive image on each page serve as a front cover or back cover image for the teaching implement; and writing the identifying information displayed on each page so that any page provides front cover or back cover information of the looping teaching implement.

To the accomplishment of the foregoing and related ends, certain illustrative aspects of the disclosed innovation are described herein in connection with the following description and the annexed drawings. These aspects are indicative of only a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The embodiments of the present invention disclosed herein are illustrated by way of example, and not by way of limitation, in the figures of the accompanying drawings, in which like reference numerals may refer to similar elements.

FIG. 1 is an exemplary embodiment of the present invention in a closed position displaying a first spinal orientation.

FIG. 2 is an exemplary embodiment of the present invention with one page being halfway rotated about the spine.

FIG. 3 is an exemplary embodiment of the present invention in a closed position displaying a second spinal orientation.

FIG. 4 top-down view of an exemplary embodiment of the present invention having one binding segment attached to each page.

FIG. 5 is a top-down view of an exemplary embodiment of the present invention wherein two binding segments are attached to each page on opposite sides of the page.

FIG. 6 is a closer, top-down view of an exemplary embodiment of the present invention showing a plurality of connections between the binding segments of FIG. 5.

FIG. 7 is an exemplary model of one cyclical concept that may be taught by the present invention.

### DETAILED DESCRIPTION OF THE PRESENT INVENTION

The innovation is now described with reference to the drawings, wherein reference numerals are used to refer to elements throughout. In the following description, for purposes of explanation, numerous specific details are set forth to provide a thorough understanding of the present invention. It may be evident that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As previously mentioned, there is a need for a teaching implement that aids in the understanding and application of cyclical thinking and problem-solving. Particularly, there is a need for a teaching implement that can provide a more adaptable, non-linear, and future-focused way of thinking to users. Building this nuanced approach to thinking and problem-solving will aid in the user's development and education.

The present invention provides such a solution to introduce cyclical thinking and problem-solving to a user as well as providing a novel design for the teaching implement that embodies the related concepts. In some embodiments, the present invention is a novel design for a teaching implement (such as a book) having a plurality of pages and at least one binding segment. Any page, having two sides (front and back), may serve as a front cover, a back cover, or an interior page of the book. The pages and their layout are designed in such a way that the writing, images, and other information are organized to be viewed as a desirable cover or interior page. Further, to aid in the understanding of cyclical thinking and problem-solving, in some embodiments, the present invention may include portions of story arcs on each side of each page. Meaning, that each page has a beginning and an ending that not only is understood in the context of that single page, but also in the connected, overarching story of the book. The effect may be accomplished by a specialized method of writing which focuses on ensuring that each page is a complete narrative arc that also fits in the greater narrative arc of the entire book. In alternative embodiments, the present invention may include units of information on each side of each page. It should be understood that “portions of a story arc” should be broadly understood and inclusive, and may refer to these units of information.

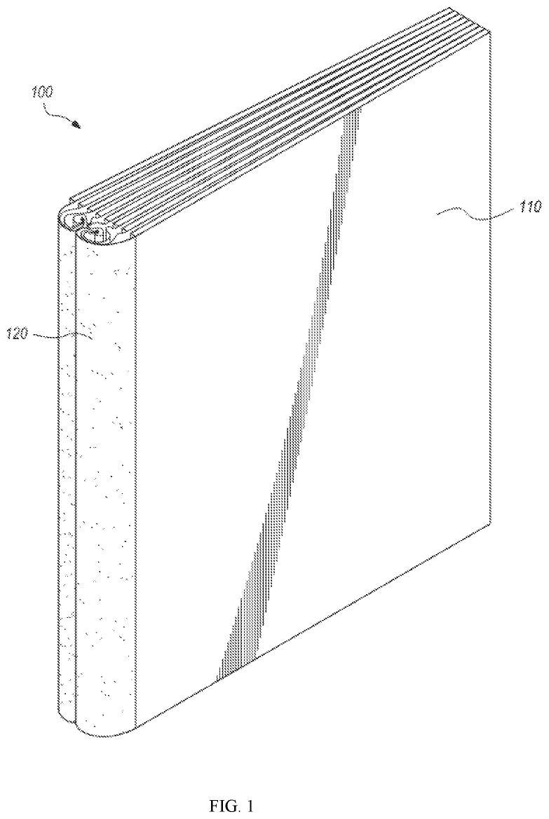

FIG. 1 is an exemplary embodiment of the present invention in a closed position displaying a first spinal orientation. In some embodiments, a teaching implement 100 may be in the form of a book having recognizable features such as a plurality of pages 110 (or simply “pages”), binding segments 120 attached to that plurality of pages 110, a spine comprised of the exteriors of at least one of the binding segments 120, one of the pages 110 serving as a front cover, and one of the pages 110 serving as a back cover. The pages 110 and binding segments 120 have a height, a width, and a thickness. The pages 110 and binding segments 120 are attached in such a way that any page 110 may serve as a front cover, a back cover, or an interior page of the teaching implement, and any of the binding segments 120 may serve as a portion of the spine of the teaching implement that is exterior to the plurality of pages 110. The pages 110 may be comprised of paper, paperboard, cloth, foam, plastic, silicone, rubber, polyethylene, and combinations thereof. The pages 110 have an inner portion and an outer portion. The inner portion of each page 110 is the part of the page near the spine of the teaching implement 100. The outer portion of each page is the part of the page opposite the spine of the teaching implement 100. In some embodiments, the inner portion and outer portion run parallel with the spine of the teaching implement 100. The spine of the teaching implement may be desirably taut when the teaching implement is in the closed position. The spine of the teaching implement may include at least one piece of identifying information for the teaching implement. Examples of identifying information for the teaching implement include the title, name of the author, an ISBN, publication information, a graphic or image, words or phrases, or other information or markings used to identify the teaching implement.

The binding segments 120 may be made of paper, paperboard, cloth, foam, plastic, silicone, rubber, polyethylene fibers, and combinations thereof. The binding segments 120 may be attached to the pages 110 via adhesives, sewn threads, compression of the binding segments and pages, and other methods known in the art. Further, each binding segment 120 is attached to at least one other binding segment 120 in addition to each binding segment's 120 attachment to one of the pages 110.

In some embodiments, the spine of the present invention may be comprised of two or more binding segments 120 that are attached in a way that provides a desirably smooth spine that is taut and provides adequate support to the teaching implement 100. The binding segments 120 may be attached to their respective pages 110 on the inner portion of each page, on a side of each page, slotted into a receiving slit on each page, or via other methods known in the art.

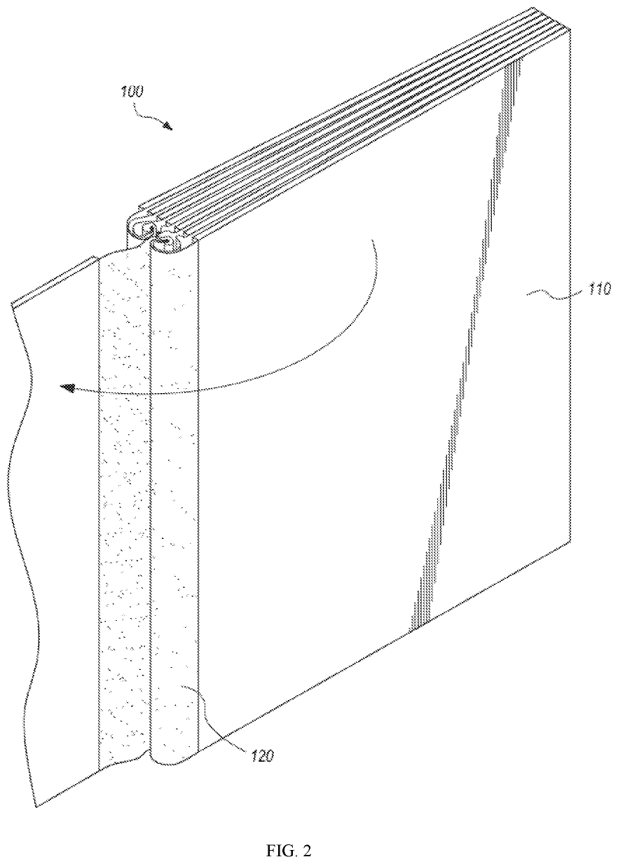

FIG. 2 is an exemplary embodiment of the present invention with one page being halfway rotated about the spine. This depiction shows that, in some embodiments, a page 110 (such as the current front page) may be rotated about the spine so that a new page 110 becomes the first page/front cover of the teaching implement 100. The binding segments 120 remain somewhat uniform in the process and the binding segment of the rotated page will become a portion of the spine created by the two binding segments 120 attached to the new front cover page 110 and the new back cover page 110 (the new back cover page being the old front cover page).

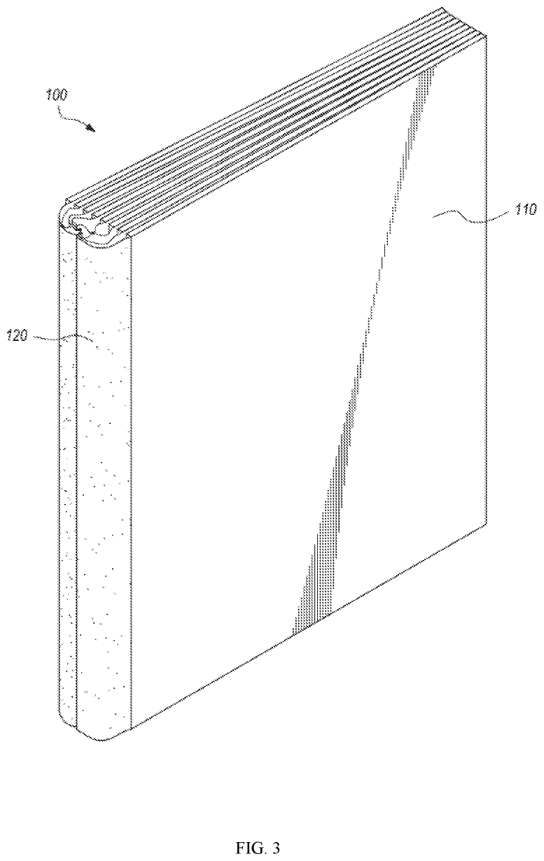

FIG. 3 is an exemplary embodiment of the present invention in a closed position displaying a second spinal orientation. In the depicted embodiment, which is the same embodiment as FIG. 1, one of the binding segments 120 is attached to two other binding segments 120 to create a spine that does not show the edges of any binding segment 120. This design is novel and useful because it creates a teaching implement 100 with pages 110 that may be rotated about the spine while always displaying a somewhat uniform spine and no “end” (in the traditional sense) to the information and/or story of the teaching implement 100.

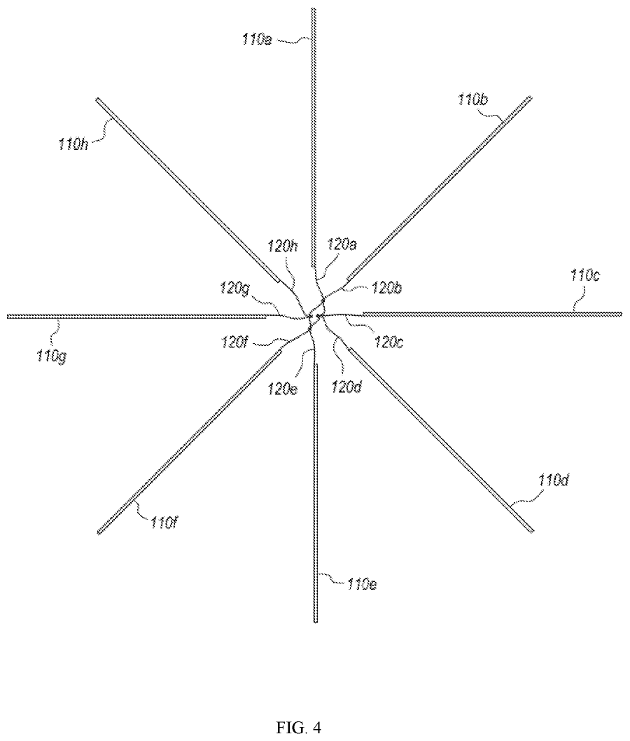

FIG. 4 is a top-down view of an exemplary embodiment of the present invention having one binding segment attached to each page. In this embodiment, each binding segment 120 (labelled individually as 120a, 120b, 120c, etc.) is attached to the same side (front or back) of the binding segment's 120 corresponding page 110 (labeled individually as 110a, 110b, 110c, etc.). This method of attachment helps create a more uniform look as a user turns the pages of the teaching implement. In alternative embodiments, the binding segments may be configured to attach to both sides of their corresponding pages. This may be accomplished with a variety of methods such as folding the binding segment to create a receiving notch (such as in the shape of a “V”) for the page or by manufacturing the binding segment to include two, parallel members that create the receiving notch for the page. In further alternative embodiments, the page may be configured to receive its corresponding binding segment in a receiving notch in the page. This embodiment would effectively hide the attachment of the pages and binding segments.

In some embodiments, pages 110 are only connected to a single binding segment 120 which is further connected to at least one other binding segment 120. The depicted embodiment shows corresponding pages 110 connected to corresponding binding segments 120. For example, page 110a is only connected to binding segment 120a, page 110b is only connected to binding segment 120b, and so on. Further, the depicted embodiment shows collections of binding segments 120 that are coupled in a cluster together with the edges of the binding segments opposite their respective pages all facing the same way, similar to a stack of papers. The depicted embodiment shows 120b, 120c, 120d, and 120e in one such cluster, and 120a, 120f, 120g, and 120h in another such cluster. The ends of the clusters are hidden when rotating a page 110 about the spine of the teaching implement 100 due to the secondary attachments between two pairs of binding segments, specifically 120a and 120b, and 120e and 120f.

In some embodiments, the secondary attachments between some of the binding segments 120 creates a pocket with an interior and exterior. The interior of the pocket contains the edges and clusters of the binding segments 120. The exterior of the pocket is the spine that is seen outside the teaching implement 100 in the closed position. The spine is relatively smooth and only shows a minimal number of seams in ideal embodiments of the invention. The clusters and additional seams of the spine helps create a durable spine that allows the present invention to be used at length with resistance to being torn, seams loosening or coming apart, fraying of the binding segments, etc. Further, the coupling of binding segments 120 in clusters help prevent interior pages 110 of the teaching implement 100 from being drawn or pulled outwards from the spine.

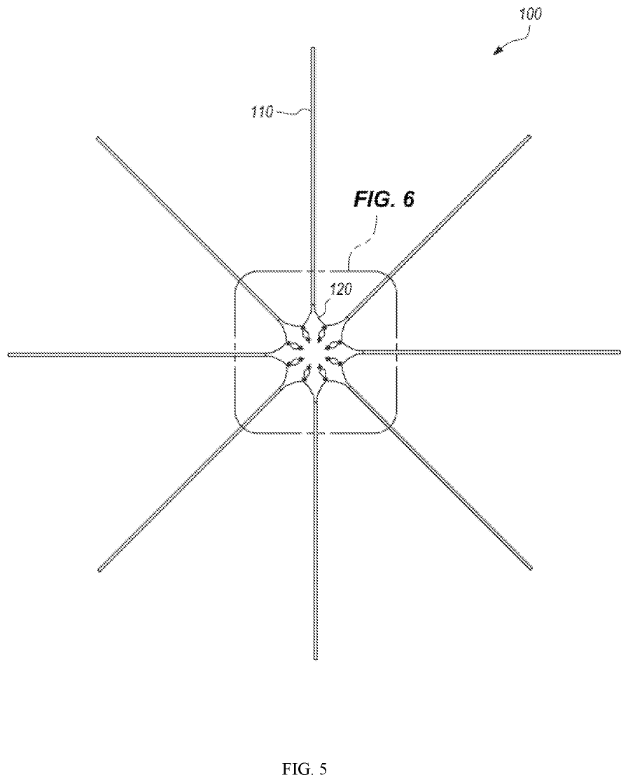

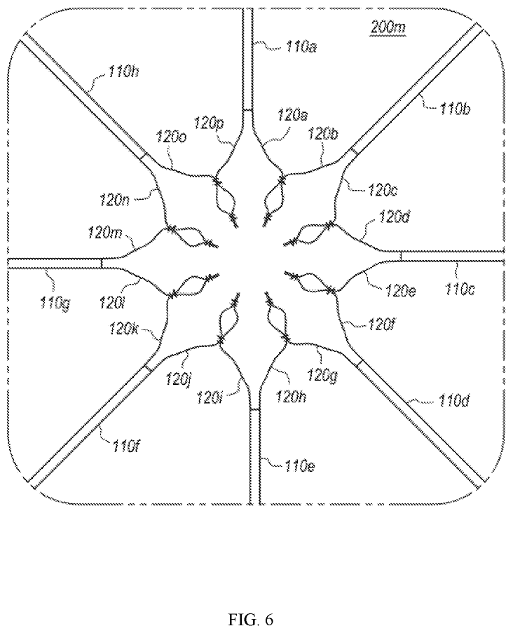

FIG. 5 is a top-down view of an exemplary embodiment of the present invention wherein each page 110 is attached to two binding segments 120 on opposite sides of the same page 120. In the depicted embodiment, the two binding segments and page create a “Y” shape where the page is the bottom of the “Y” and each binding segment is one of the upward branching arms of the “Y.” The depicted embodiment also identifies a zoomed in section representing FIG. 6.

FIG. 6 is a zoomed in, top-down view of an exemplary embodiment of the present invention showing a plurality of connections between the binding segments of FIG. 5. In some embodiments, the binding segment attached to the front side of one page is coupled to the binding segment attached to the back side of another page. For example, binding segment 120a, that is attached to the front side of page 110a, is also coupled with binding segment 120b, that is attached to the back side of page 120b. The depicted embodiment shows that this coupling process is performed with every page desired to be in the teaching implement created by the pages 110 and binding segments 120.

In some embodiments, the binding segments may be coupled to one another at about the end of each binding segment's end opposite that binding segment's attachment to that binding segment's corresponding page. The attachment of these binding segments should be in a way where the ends of the binding segments (opposite the ends that are attached to their respective pages) are within an interior pocket created by the plurality of attached binding segments. In ideal embodiments, the outside of this pocket leaves a desirably smooth and uniform seam location for the spine of the present invention. In the depicted embodiment, the binding segments 120 are coupled at the middle and end of the binding segment opposite the binding segments attachment to that binding segment's corresponding page. This double coupling may create more durable couplings and/or help organize and prevent damage to the ends of the binding segments in the interior pocket. In even further embodiments, the ends of the binding segments opposite their ends that are attached to their corresponding pages, may be coupled in a cluster or clusters in order to provide additional durability to the spine of the teaching implement and the seams created by sewing two binding segments together at about the middle of their width. Having clusters of binding segments also may help the teaching implement keep its shape.

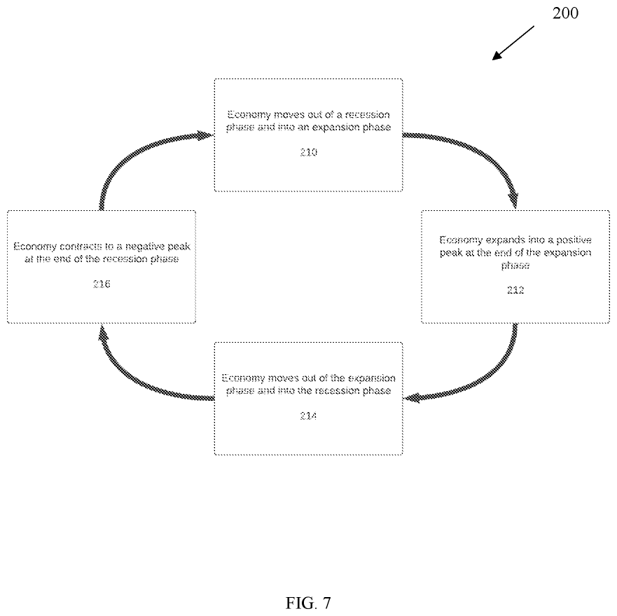

FIG. 7 discloses an exemplary story structure that may be ideally conveyed by the present invention. The method of writing a story designed for a teaching implement comprises developing and writing a story or conveying information that relates to a cyclical concept. One exemplary concept is the cycle of expansion and recession in a country's economy 200. In this example, a first point in the concept is given such as the “economy moves out of a recession phase and into an expansion phase” 210. The first point connects to a second point 212. The second point connects to a third point 214. The third point connects to a fourth point 216. And the fourth point loops back to connect to the first point 210.

In desirable embodiments of the present invention, the cyclical concept may be started at any point (210, 212, 214, 216) within the teaching implement. As the user reads the pages of the teaching implement, both the information and/or story of each page is conveyed. Additionally, the cyclical concept (such as recession and expansion of an economy) is conveyed to the user through repeated cycling of the pages. This reinforcement of the concepts taught by the teaching implement creates deeper understanding for the user.

Another exemplary story structure that is reinforced by the present invention is the life cycle of a chicken. The story may start at any point in the cycle. One such starting point is “A chick is hatched from an egg.” Next, “The chick grows and matures into a chicken.” Then, “the chicken mates with a rooster and produces an egg.”

In some embodiments, the present invention requires a unique method of writing a story designed for the teaching implement. First, the writer must write content on each page of the teaching implement so that each page contains a portion of a story arc. This episode portion may be part of a greater cyclical story conveyed through the teaching implement. The writer must structure each page in such a way that the words leave room for an attractive image and identifying information of the teaching implement to be displayed on each page. The structure of each page, in some embodiments, may include text being written around the exterior sections of the page so that room is left in the center of the page for the attractive image and identifying information. In alternative embodiments, the text may be written along the top and down a portion of one of the sides of the page, leaving room for the attractive image and identifying information on the other side of the same page. The teaching implement having the attractive image on each page better creates the desired effect of each page being able to serve as the front cover or back cover. Further, in desirable embodiments, the writer should include identifying information on each page so that any page provides front cover or back cover information of the looping teaching implement.

In some embodiments, the center of the page of the teaching implement contains a relatively large space where identifying information and an attractive image or picture may be placed to serve as a front or back cover of the teaching implement.

In some embodiments, the pages that serve as a front cover of the teaching implement include a more prominent design than the pages that serve as a back cover of the teaching implement. In this embodiment, pages serving as back covers of the teaching implement may include more prominent writing and text opposed to the prominent images of their counterparts. These embodiments may be desirable because the user could read, while the teaching implement is “open,” the majority of text on the “left” (back cover) page of the teaching implement while viewing the prominent design or image on the “right” (front cover) page of the teaching implement.

In alternative embodiments, the plurality of pages may be used without binding segments but connected to one another in a way that a similar effect is achieved. These embodiments, while having less pieces and possibly easier to assemble, lack some of the benefits of other embodiments such as durability.

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods, systems, and apparatus described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A teaching implement for teaching cyclical concepts, comprising:
a plurality of pages, each page having two sides, each page having an inner portion and an outer portion, and each page capable of serving as a front cover, a back cover, or an interior page of the teaching implement; and
a plurality of binding segments wherein at least one binding segment is attached to each page at the inner portion of that page, each binding segment being attached to at least one other binding segment, and wherein any set of adjacent attached binding segments may serve as a spine for the teaching implement.

2. The teaching implement of claim 1 wherein the plurality of pages is made of paper, paperboard, cloth, foam, plastic, silicone, rubber, polyethylene fibers, and combinations thereof.

3. The teaching implement of claim 1 wherein the plurality of binding segments is made of cloth, plastic, paper, plastic, silicone, rubber, polyethylene fibers, and combinations thereof.

4. The teaching implement of claim 1 wherein each binding segment is about the height of the page to which that binding segment is attached.

5. The teaching implement of claim 1 wherein each binding segment is part of at least one cluster of binding segments coupled at their respective ends opposite those binding segments' attachments to their respective pages, and wherein at least one pair of binding segments are coupled at a point between their ends in the cluster and their ends attached to their respective pages, creating a pocket having an interior and exterior, and wherein the interior of the pocket contains at least one cluster of coupled binding segments and the exterior of the pocket serves as the teaching implement's spine.

6. The teaching implement of claim 5 wherein the spine created by the exterior of the pocket displays at least one identifying information of the teaching implement.

7. The teaching implement of claim 6 wherein the identifying information contains an author's name, a title of the teaching implement, an ISBN of the teaching implement, other identifying information, or combinations thereof.

8. The teaching implement of claim 1 wherein each page has two attached binding segments, the first binding segment attached to one side of the page at the inner portion and the second binding segment attached to the other side of the same page at the inner portion, and wherein the two binding segments attached to one page are attached to binding segments of different pages creating a pocket with an interior containing the ends of the binding segments opposite of the end of each binding segment attached to its respective page and an exterior serving as the teaching implement's spine.

9. The teaching implement of claim 8 wherein the binding segments are coupled together in at least one cluster within the interior of the pocket.

10. The teaching implement of claim 8 wherein the spine created by the exterior of the pocket displays at least one identifying information of the teaching implement.

11. The teaching implement of claim 10 wherein the identifying information contains an author's name, a title of the teaching implement, an ISBN of the teaching implement, other identifying information, or combinations thereof.

12. The teaching implement of claim 1 wherein each front and each back of each page teaches part of a narrative arc of a cyclical concept.

13. The teaching implement of claim 1 wherein each front and each back of each page teaches information regarding a portion of a cyclical concept.

14. The teaching implement of claim 1 wherein each page serving as a front page of the teaching implement prominently features an aesthetic design.

15. The teaching implement of claim 14 wherein each page serving as a back page of the teaching implement prominently features text.

16. A method of writing designed for a teaching implement for teaching cyclical concepts, the method comprising:
writing the content of each page of the teaching implement so that each page contains a portion of a story arc that is part of a greater cyclical story conveyed through thematically connected story arcs of a plurality of pages that comprise the teaching implement;
structuring each page such that the words leave room for an attractive image and identifying information of the teaching implement to be displayed on each page;
having the attractive image on each page serve as a front cover or back cover image for the teaching implement; and
writing the identifying information displayed on each page so that any page provides front cover or back cover information of the looping teaching implement.
